(19) United States
(12) Patent Application Publication
(10) Pub. No.: US 2004/0187699 A1
(43) Pub. Date: Sep. 30, 2004

(54) Fowl steamer/smoker grilling device

(76) Inventors: Andrew Citrynell, Carbondale, CO (US); Kimberly Ann Miller, Carbondale, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/727,364

(22) Filed: Dec. 3, 2003

Related U.S. Application Data
(63) Continuation-in-part of application No. 10/400,988, filed on Mar. 26, 2003.

(51) Int. Cl. A47J 37/10

(52) U.S. Cl. 99/345; 99/419; 99/426

(57) ABSTRACT

A grilling system comprises a heat conductive grilling base having a bottom end and an open top end. The base defines a cavity that extends to the open top end. A grill member has an open bottom end, an open top end, and a conduit passing from the bottom end to the top end. The grill member is configured to be coupled to the grilling base so as to extend vertically upward from the top end of the base to permit a fowl to be inserted over the grill member and rest on the base while also permitting smoke or steam rising from the cavity to pass through the grill member to flavor the fowl.

### CROSS REFERENCES TO RELATED APPLICATIONS

This application is a continuation in part application and claims the benefit of copending U.S. application Ser. No. 10/400,988, filed Mar. 26, 2003, the complete disclosure of which is herein incorporated by reference.

### BACKGROUND OF THE INVENTION

This invention relates generally to the field of cooking fowl, and in particular to providing steam and/or smoke to the internal body cavity of the fowl using a grill.

Traditional techniques for cooking fowl generally require the fowl to be placed in a roasting pan that is then inserted into an oven. While roasting is perhaps the most popular way to cook fowl, grilling is another common technique. Grilling may be accomplished by cutting up the fowl and grilling the individual pieces, by placing the entire fowl on a grill, by using a rotisserie, and the like.

Another grilling technique is to place a beer or soda pop can into the interior of the fowl. One example of this technique is described in U.S. Pat. No. 6,503,351, the complete disclosure of which is herein incorporated by reference.

The invention provides other alternatives from cooking fowl using various grilling techniques. In so doing, the invention permits the internal body cavity of the fowl to be cooked while also providing flavoring using smoke and/or liquid vapors that are delivered to the internal cavity of the fowl.

### BRIEF SUMMARY OF THE INVENTION

As just alluded to, the invention provides systems and methods for cooking fowl in such a way that heat is provided not only to the external part of the fowl, but also to the internal body cavity of the fowl by using grilling techniques. Further, the internal cavity of the fowl may be flavored and moistened using smoke and/or liquid vapors.

In one embodiment, the invention provides a grilling system that comprises a heat conductive grilling base having a bottom end and an open top end. The bottom end is configured to be placed onto a conventional grill. The base defines a cavity that extends to the open top end. The system further comprises a grill member having an open bottom end, an open top end, and a conduit passing from the bottom end to the top end. The grill member is configured to be coupled to the grilling base so as to extend vertically upward from the top end of the base. In this way, a fowl may be inserted over the grill member and rest on the base while also permitting smoke or steam rising from the cavity to pass through the grill member to flavor the fowl.

The grill member may be provided with a plurality of holes distributed between the top end and the bottom end to permit the smoke or steam to also pass laterally outward into the fowl. In this way, the interior of the fowl may be flavored while also being grilled.

In one aspect, the grill member may be constructed of metal and be cylindrical in geometry. The base may also be constructed of metal and be generally conical in geometry. In this way, the base transfers heat from the grill to the grill member, while also providing appropriate stability to the fowl.

In another aspect, the base and the grill member may include connectors to permit the grill member to be coupled to the base. For example, the connectors may comprise threads to permit the grill member to be screwed into the base. As another example, the connectors may comprise detents that fit within slots when the grill member is twisted in the base. As a further example, the grill member may be press fit within base. As still another example, the grill member may include tabs and the base may include slots into which the tabs are inserted. The grill member may then be rotated relative to the base to lock the grill member in place.

One particular feature is the use of an insert that may be placed within the cavity to hold a liquid. When the base is heated, the steam passes up through the grill member and into the fowl. Conveniently, the insert may comprise a cup shaped member that is constructed from a ceramic or other material capable of hold liquid and being heated to grill temperatures. Following grilling, the system may be disassembled and placed into a dishwasher for easy cleaning. The insert may include one or more tabs to facilitate removal of the insert from the base.

The invention also provides an exemplary method for cooking fowl. The method utilizes a heat conductive grilling base having a bottom end and an open top end. The base defines a cavity that extends to the open top end. A substance, such as a liquid or wood chips, is placed into the cavity. If a liquid is used, the liquid is preferably placed into a container or insert (such as a ceramic insert) that is placed into the cavity. A grill member is coupled to the base and has an open bottom end, an open top end, a conduit passing from the bottom end to the top end, and a plurality of openings distributed between the top end and the bottom end. The grill member is coupled to the base so as to extend vertically upward from the top end of the base. A fowl is placed over the grill member such that the grill member extends upward into the fowl's body cavity, with the base holding the fowl in a generally vertical orientation. The base is heated to transfer heat to the grill member and to cause the substance to smoke or steam, with the smoke or steam passing up through the conduit and into the fowl through the openings and through the open top end of the grill member.

To heat the base, it may be placed onto a barbecue grill or other heating element. When using wood chips, they may be placed directly into the cavity. When using a liquid, it may be placed directly into the cavity or it may be poured into an insert that is placed into the cavity. Further, the liquid may be seasoned.

The various components may be detached from each other to facilitate cleaning. For example, the grill member may be screwed or twisted into the base to couple to grill member to the base.

In one aspect, the base may comprise a metal fashioned in a conical shape to permit greases from the fowl to run down the base and into the barbecue grill. However, other shapes may be used, such as square, pyramidal, rectangular, cylindrical, hour glass and the like. Also, the grill member may also have a variety of shapes. Further, the grill member may comprise a metal fashioned in a cylindrical shape such that heat from the base is transferred to the interior of the fowl via the grill member.

In some cases, a collection plate may be coupled to the base. The collection plate is designed to collect greases, liquid or other substances so that they do not run down the base. In this way, the system may be used indoors, such as on an indoor grill. Also, a lid may be used to fit over the fowl while being cooked. The lid helps to hold in heat as well as trapping smoke and/or vapors. The lid may also be used following cooking to help keep the fowl warm.

### BRIEF DESCRIPTION OF THE DRAWINGS

FIG. 1 is a front view of an embodiment of a grilling system according to the invention.

FIG. 2 is a partially exploded and cutaway side view of the grilling system of FIG. 1.

FIG. 3 is a fully exploded and partially cutaway side view of the grilling system of FIG. 1.

FIG. 4 is a top perspective view of the grilling system of FIG. 2.

FIG. 5 is a top perspective view of an alternative grilling system according to the invention.

FIG. 6 is a side view of the grilling system of FIG. 5.

FIG. 7 is a top view of the grilling system of FIG. 5.

FIG. 8 is a bottom perspective view of a grilling member of the system of FIG. 5.

FIG. 9 is a top perspective view of a grill base of the system of FIG. 5.

FIG. 10 is a cross sectional side view of the grill base of FIG. 9.

FIG. 11 is a top perspective view of an insert of the system of FIG. 5.

FIG. 12 is a top perspective view of another embodiment of a grilling system according to the invention.

FIG. 13 is a top perspective view of a grill member of the system of FIG. 12.

FIG. 14 is a top perspective view of a grill base of the system of FIG. 12.

FIG. 15 is a top perspective view of an insert of the system of FIG. 12.

FIG. 16 is a top perspective view of an alternative grill base according to the invention.

FIG. 17 is a top perspective view of still another alternative grill base according to the invention.

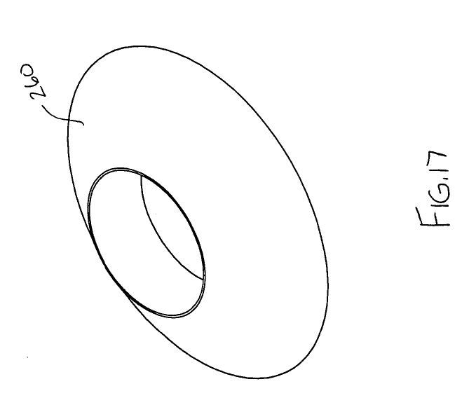

FIG. 18 is a top perspective view of an alternative embodiment of a grill member according to the invention.

FIG. 19 is a perspective view of another embodiment of a grilling system according to the invention.

FIG. 20 is a front view of the grilling system of FIG. 19.

FIG. 21 is a front perspective view of a grill base of the system of FIG. 19.

FIG. 22 is a front perspective view of a grill base and a collection plate of the grilling system of FIG. 19.

FIG. 23 is a top view of grill base and collection plate of FIG. 22.

FIG. 24 is a perspective view of the collection plate of FIG. 22.

FIG. 25 is a perspective view of a an insert of the system of FIG. 19.

FIG. 26 is a perspective view of a grill member of the system of FIG. 19.

FIG. 27 is a front view of a lid that may be used with the system of FIG. 19.

### DETAILED DESCRIPTION OF THE INVENTION

The invention provides grilling systems and methods that may be used to cook fowl and other meats and vegetables. One particular advantage of the invention is that a grill or other heating element may be used to heat a grill material that is placed within the fowl while also permitting the fowl to be steamed and/or smoked. To do so, the fowl may be placed onto a grill member, such as a cylinder, that is held by a thermally conductive base. The cylinder may be made from a grill material to grill the meat. When used as a steamer, the steam from the liquid rises from the base and through the cylinder where it enters into the body cavity and flavors the fowl. When used as a smoker, the smoke rises in a similar manner to smoke the fowl while it is being cooked. Another feature is that the grilling systems may be sized to occupy only a portion of the grill upon which it rests. As such, other food items may be grilled in the traditional fashion on the same grill which is supplying heat to the grilling system.

When steaming, essentially any type of liquid may be used. Examples of liquids that may be used include wine, beer, soda pop, fruit and vegetable juices, water, liquid spices, along with any flavorings or other spices, and the like. The liquid may conveniently be placed into a holder, such as a ceramic or metal insert that in turn may be held within the base, or the liquid may be poured directly into the cavity of the base. The insert may include a handle, tabs or the like to help grasp and remove the insert. The base may conveniently be constructed of a heat conductive material, such as metal, to transfer heat to the liquid as well as to the grill member. The base is preferably heavy enough to hold the fowl vertically, and may have a conical shape to permit fat and greases to drip downward where they run off the base and into the grill. In some embodiments, a collection plate that is coupled to the base may be used to prevent fat and greases from running down the base.

The grill member serves to hold the fowl upright while the base rests on a grill or other heating element. The grill member may have various openings to permit the vapor from the heated liquid to pass laterally outward into the fowl. If circular, such holes may have a diameter in the range from about 1/16 inch to about 1 inch, and more preferably about ¼ inch. Other shaped holes may also be used and may have similar area dimensions. The holes may be spaced apart by a distance in the range from about ¼ inch to about 1.5 inches, and more preferably from about ½ inch to about 1.25 inches. The density of holes may be about 0.5 per inch to about 1 per inch, and more preferably about 0.75 per inch. The height of the grill member may vary depending on the fowl being grilled. For example, for chicken or ducks, the grill member may have a height in the range from about 4 to about 6 inches, and more preferably about 5 inches, and may have a diameter in the range from about 2 inches to about 4 inches, and more preferably about 3 inches. These dimensions may be smaller for smaller fowl, such as Cornish game hens, and larger for larger fowl, such as geese and turkey.

This process flavors and moistens the meat as the fowl is cooked from the inside due to contact from the heated grill member. The fowl also cooks externally due to the heat of the grill on which the base rests. Thus, flavoring, moisturizing and cooking occur at an accelerated rate, due to the fact that the fowl is being cooked from inside and out. This produces a better tasting, moister, faster cooking and healthier fowl.

When smoking, the insert may be removed from the base, and flavored, moist wood chips may be placed into the cavity in the base. The grill member may then be attached to the base, and the fowl placed onto the grill member. The base may then be placed onto a grill and heated to cause the chips to smoke. As the smoke rises from the chips, it passes through the holes in the grill member. This flavors the meat as the fowl is cooked from the inside due to contact from the heated grill member. The fowl also cooks externally from the heat of the grill on which the base is resting. Thus, smoking, flavoring and cooking all occur at an accelerated rate because the fowl is being cooked from the inside and out.

Following cooking, the device can be removed from the grill and separated into its component parts. These may be placed into the dishwasher for washing. This makes the process more hygienic than a regular grill, which often has residue remaining from previous uses.

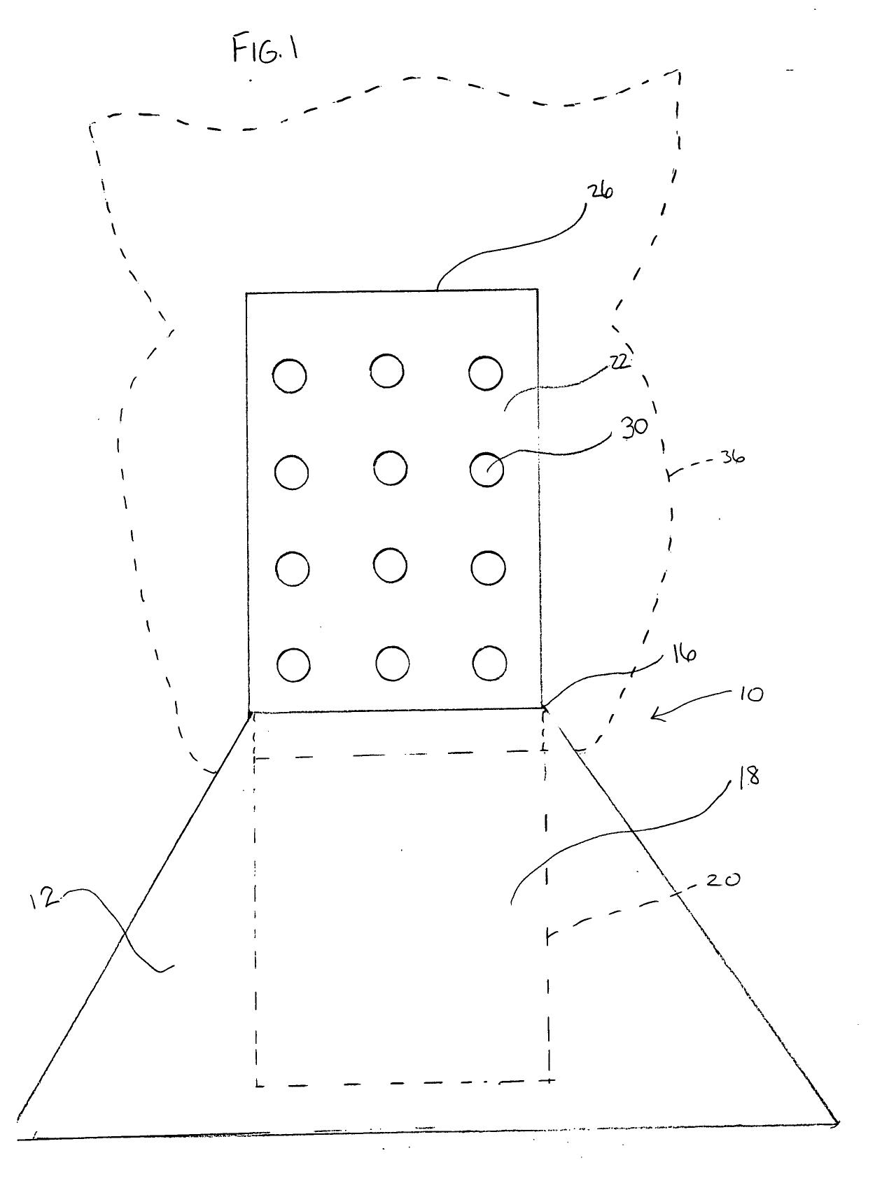

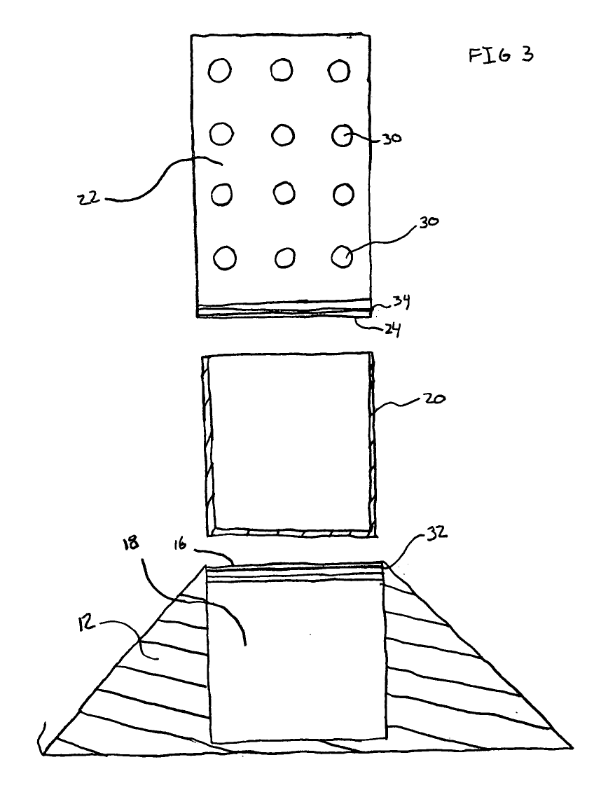

Referring now to FIGS. 1-4, one embodiment of a grilling system 10 will be described. Grilling system 10 comprises a base 12 that is constructed of a thermally conductive material, such as a metal or other grill material commonly used with grills. Base 12 is shown as being generally conical in geometry, although other shapes may be used as well. However, the conical shape provides a low center of gravity to enable to base to support a fowl, as well as permitting fluids and greases from the fowl to flow down its sides and into the grill. Base 12 has a bottom end 14 that is configured to directly rest on a grill and an open top end 16. Formed within base 12 is a cavity 18 that may be used to hold a substance that is used to create a smoke or vapor. In some cases, the substance may be held directly in cavity 18, while in other cases, an insert 20 may be placed into cavity and used to hold the substance. Insert 20 may be constructed of any material that is bio-compatible with food and that may withstand grilling temperatures. Examples of materials that may be used include ceramics, metals, composites, and the like. Insert 20 may easily be removed from cavity 18 for cleaning and to permit substances to be placed directly into cavity 18.

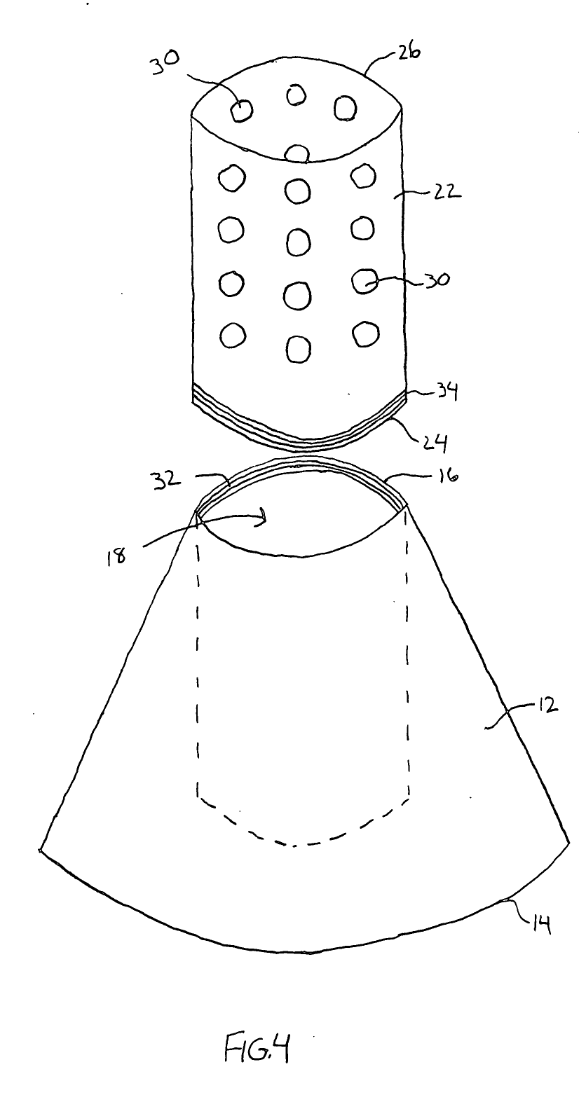

System 10 also includes a grill member 22 having an open bottom end 24, an open top end 26 and a conduit 28 (see FIG. 4) passing between the two ends. Grill member as shown is cylindrical in geometry, although it will be appreciated that other shapes may be used, including those specifically tailored to mate with the interior cavity of a particular fowl, meat, or vegetable. Formed within the walls of grill member 22 are holes 30 that permit smoke and/or vapors to pass laterally through grill member 22 and into a fowl.

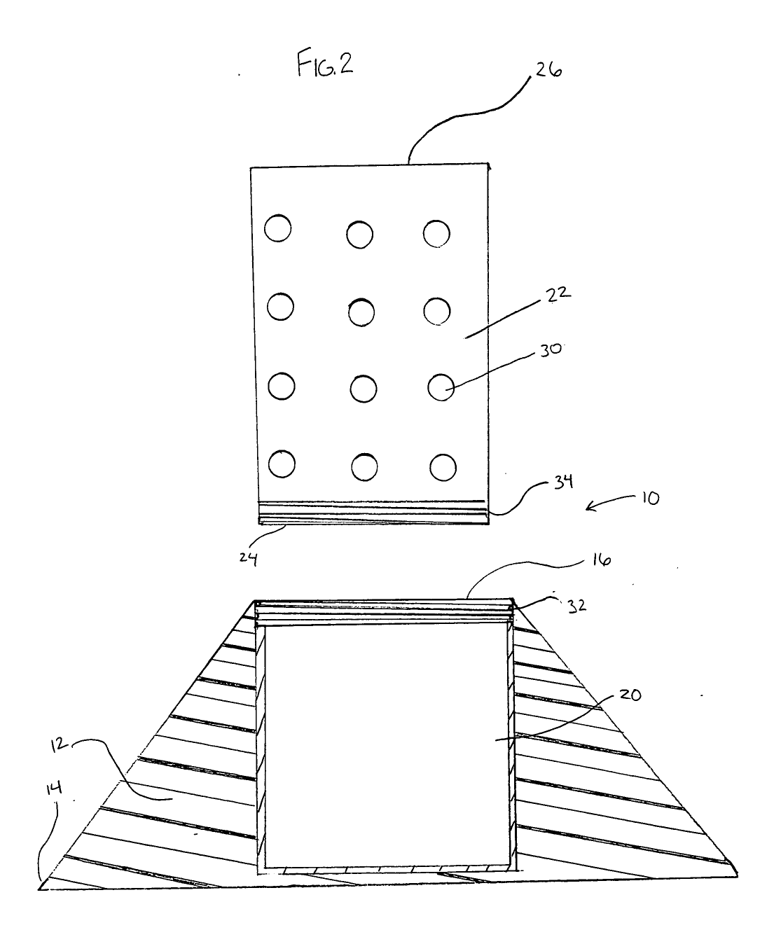

As shown in FIGS. 2-4, base 12 includes threads 32 in top end 16 while grill member 22 also includes mating threads 34 at bottom end 24. In this way, grill member 22 may easily be screwed into base 12 to the position shown in FIG. 1. As such, grill member 22 may easily be removed, such as when needed to insert or remove insert 20, or for cleaning. Although shown with threads, it will be appreciated that other connectors may also be used, such as detents, clips, screws, or the like.

System 10 may be used in one of two modes. In one mode, insert 20 is not used. Instead, moist wood chips, liquids or other substances may be placed into cavity 18 and grill member 22 may be screwed into base 12. A fowl 36 (see FIG. 1) may be placed over grill member 22 such that grill member 22 fits within the internal body cavity of the fowl. The weight of the fowl causes the neck end of the fowl to rest upon the top of base 12. The conical shape of base 12 serves to prevent fowl 36 from sliding completely over base 12. Further, base 12 has a bottom end that is sufficiently wide and heavy to maintain the fowl in a generally upright orientation when base 12 is resting on the grill.

With base 12 resting on a grill, the grill may be heated to transfer heat directly to the fowl as well as to base 12. The heat from base 12 is transferred to grill member 22 to grill and cook the inside of the fowl. At the same time, the substance in cavity 18 is heated causing steam and/or smoke to pass upward through grill member 22 and out top end 26, as well as through holes 30 to moisten, cook and flavor the fowl. In this way, the fowl may be cooked both externally and internally while also moistening and flavoring the meat.

The second mode of operation is similar to the first mode except that insert 20 is included within cavity 18. A liquid may be poured into insert 20, either before or after grill member 22 is coupled to base 12. When heat is applied from the grill, the heat causes steam from the liquid within insert 20 to pass upwardly through grill member 22 in a manner similar to that previously described.

Following cooking, the fowl is removed from grill member 22. System 10 may then be disassembled for easy washing and cleaning. For example, each of the components may easily fit within a conventional dishwasher.

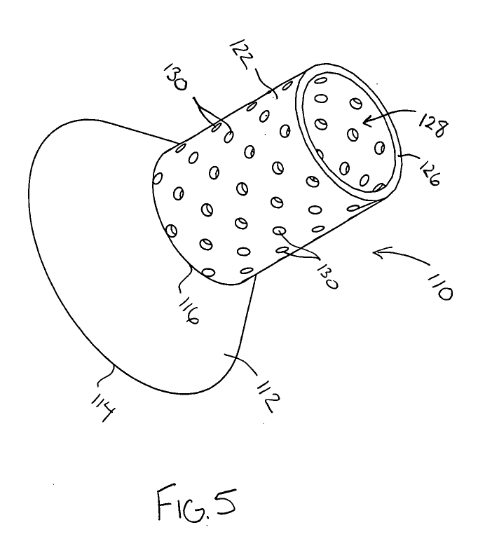

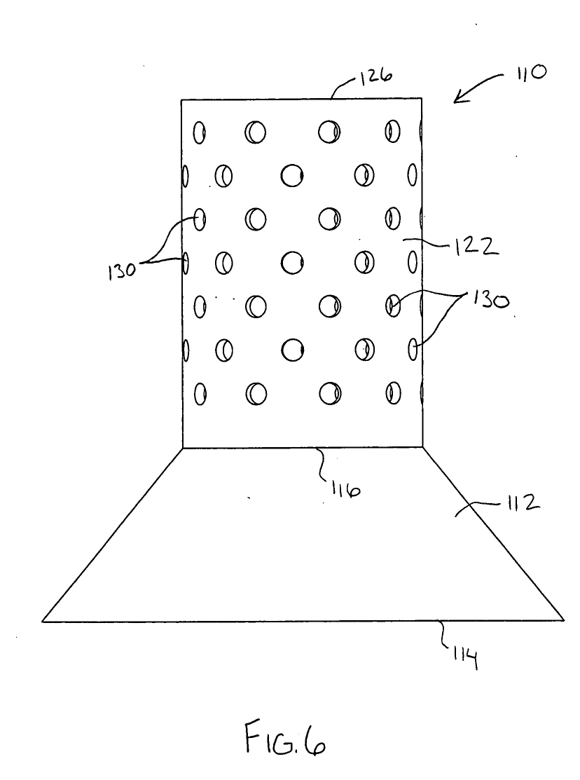

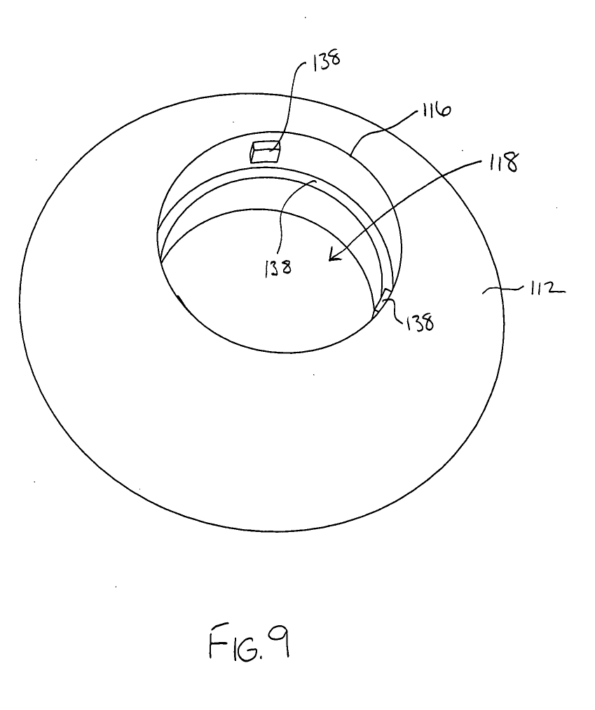

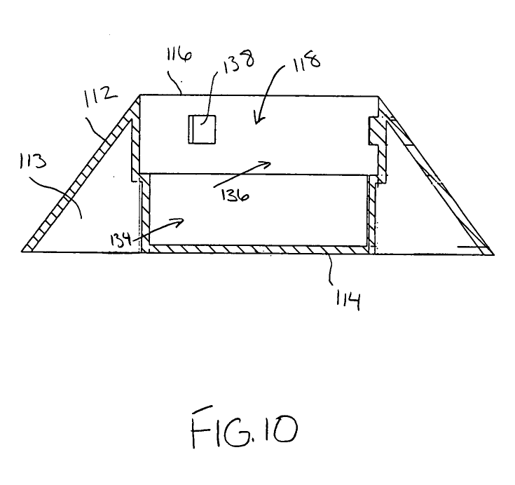

Referring now to FIGS. 5-7, another embodiment of a grilling system 110 will be described. Grilling system 110 comprises a base 112 that is constructed of a thermally conductive material, such as a metal or other grill material commonly used with grills. Base 112 is shown as being generally conical in geometry, although other shapes may be used as well. However, the conical shape provides a low center of gravity to enable to base to support a fowl, as well as permitting fluids and greases from the fowl to flow down its sides and into the grill. As also shown in FIGS. 9 and 10, base 112 has a bottom end 114 that is configured to directly rest on a grill and an open top end 116. Formed within base 112 is a cavity 118 that may be used to hold a substance that is used to create a smoke or vapor. The size of base 112 may vary depending upon the fowl being grilled. For chicken or duck, base 112 may have a diameter at bottom end 114 that is in the range from about 5 inches to about 7 inches, and more preferably about 6 inches. The height of base 112 may be in the range from about 1 inch to about 3 inches, and more preferably about 2 inches. However, base 112 may be made larger or smaller depending on the size of the fowl. To reduce the weight and manufacturing costs, base 112 may include a hollow region 113.

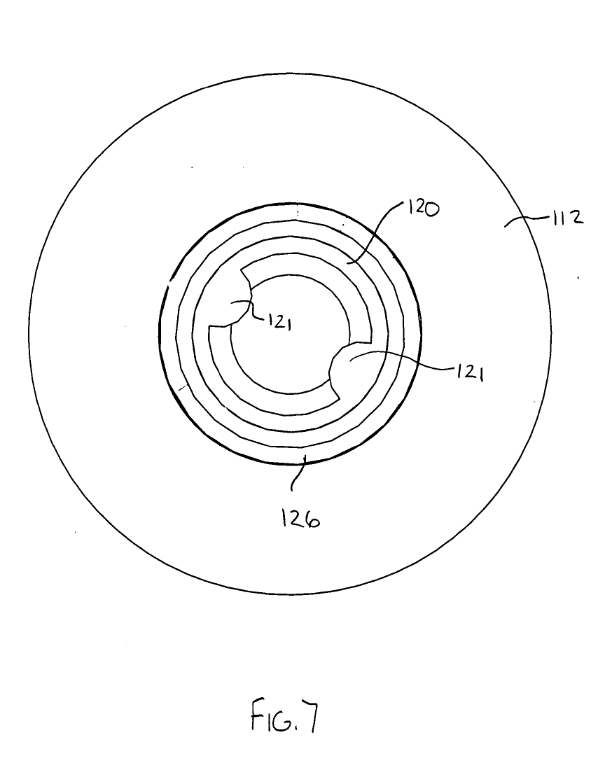

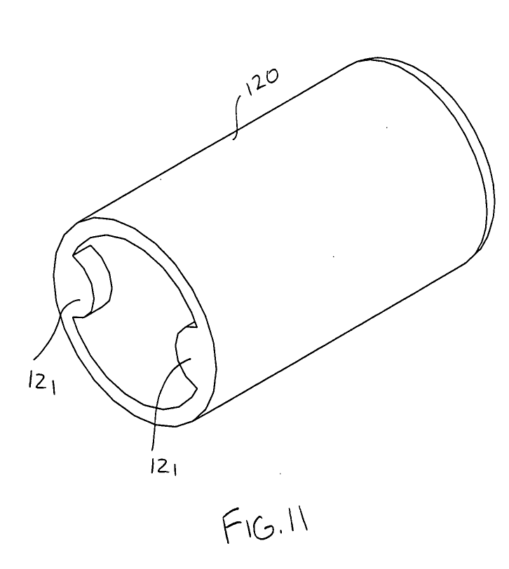

In some cases, the substance may be held directly in cavity 118, while in other cases, an insert 120 (see FIGS. 7 and 11) may be placed into cavity and used to hold the substance. Insert 120 may be constructed of any material that is bio-compatible with food and that may withstand grilling temperatures. Examples of materials that may be used include ceramics, metals, composites, and the like. Insert 120 may easily be removed from cavity 118 for cleaning and to permit substances to be placed directly into cavity 118. To help insert and remove insert 120, it may include one or more tabs 121 at its top end.

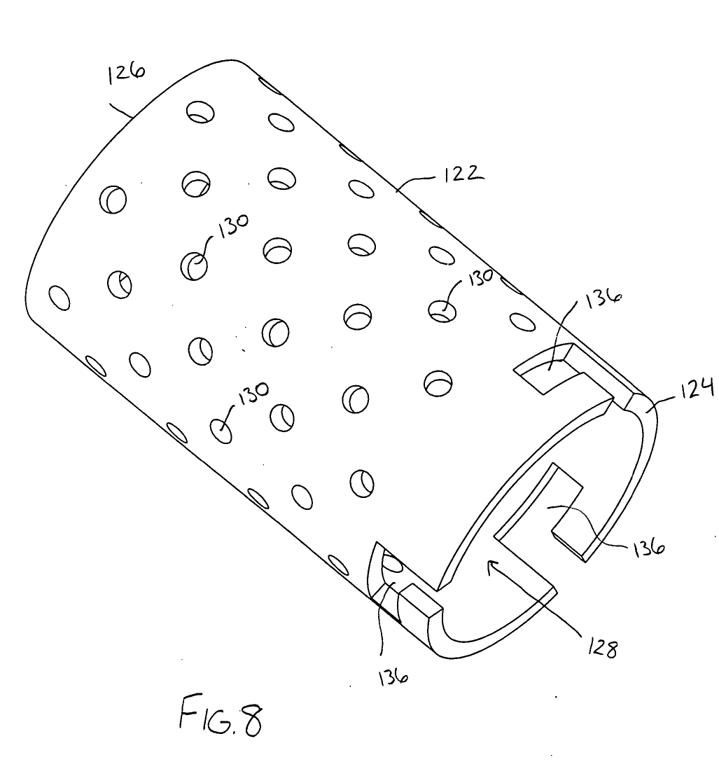

System 110 also includes a grill member 122 (see also FIG. 8) having an open bottom end 124, an open top end 126 and a conduit 128 passing between the two ends. Formed within the walls of grill member 122 are holes 130 that permit smoke and/or vapors to pass laterally through grill member 122 and into a fowl. Grill member 122 may be constructed of a grill material, such as stainless steel, aluminum or the like. For grilling chicken or duck, grill member 122 may have a height of about 5 inches, and an external diameter 3 inches and an internal diameter of about 2.6 inches. Further, holes 130 may be about ¼ inch in diameter. Holes 130 may be vertically spaced apart by about 0.5 inches. However, other sizes may be used as well.

As best shown in FIG. 10, cavity 118 of base 112 has a lower region 134 and an upper region 136 that is larger in diameter than lower region 134 to form a ledge 138. This permits insert 120 to sit within lower region 134 and to extend up into grill member 122 which sits within upper region 136. Insert 120 is preferably high enough to maximize the amount of liquid that it may hold while also being low enough to not block holes 130. Hence, insert 120 may extend up into grill member 122 when system 110 is assembled.

As best shown in FIG. 8, grill member 122 includes a set of L-shaped slots 136 in bottom end 124. Base 112 also includes a corresponding number of detents 138. In this way, grill member 122 may be coupled to base 112 by inserting bottom end 124 into cavity 118 until detents 138 pass into slots 136 and bottom end 124 rests on ledge 138. Base 112 and grill member 122 are rotated relative to each other to move detents 138 further into the slots. Base 112 and grill member 122 may be disassembled by rotating them in the opposite direction.

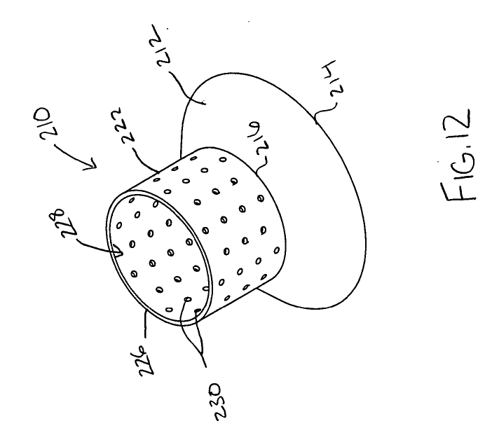

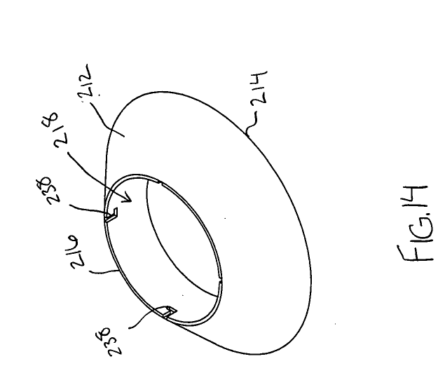

FIGS. 12-14 illustrate another embodiment of a grilling system 210 that is similar to grilling system 110 except for its size and the type of connectors. Grilling system 210 comprises a base 212 that is constructed of a thermally conductive material, such as a metal or other grill material commonly used with grills. Base 212 is shown as being generally conical in geometry, although other shapes may be used as well. However, the conical shape provides a low center of gravity to enable to base to support a fowl, as well as permitting fluids and greases from the fowl to flow down its sides and into the grill. As also shown in FIG. 14, base 212 has a bottom end 214 that is configured to directly rest on a grill and an open top end 216. Formed within base 212 is a cavity 218 that may be used to hold a substance that is used to create a smoke or vapor. The size of base 112 may vary depending upon the fowl being grilled. Grilling system 210 is particular suited for grilling small fowl, such as Cornish game hens. However, base 212 may be sized differently depending on the size of the fowl. To reduce the weight and manufacturing costs, base 212 may include a hollow region similar to base 112.

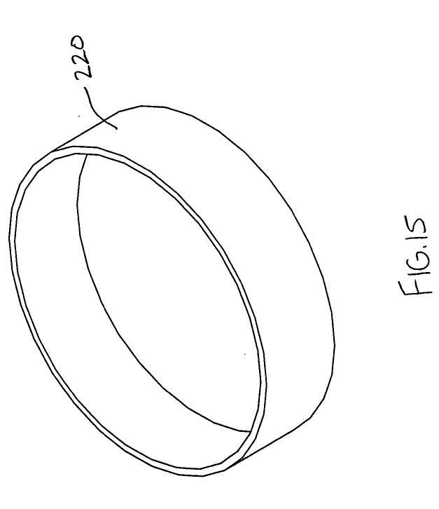

In some cases, the substance may be held directly in cavity 218, while in other cases, an insert 220 (see FIG. 15) may be placed into cavity and used to hold the substance. Insert 220 may be constructed of any material that is bio-compatible with food and that may withstand grilling temperatures. Examples of materials that may be used include ceramics, metals, composites, and the like. Insert 220 may easily be removed from cavity 218 for cleaning and to permit substances to be placed directly into cavity 218.

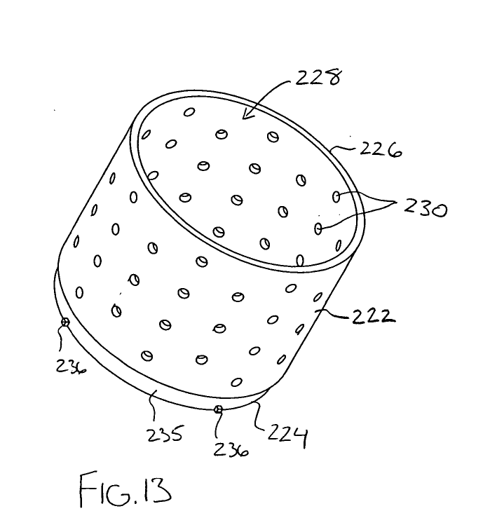

System 210 also includes a grill member 222 (see also FIG. 13) having an open bottom end 224, an open top end 226 and a conduit 228 passing between the two ends. Formed within the walls of grill member 222 are holes 230 that permit smoke and/or vapors to pass laterally through grill member 222 and into a fowl. Grill member 222 may be constructed of a grill material, such as stainless steel, aluminum or the like. Holes 230 may be about ¼ inch in diameter. Holes 230 may be vertically spaced apart by about 0.5 inches. However, other sizes may be used as well.

As best shown in FIG. 14, cavity 218 of base 212 is sized to receive insert 220. Insert 220 is preferably high enough to maximize the amount of liquid that it may hold while also being low enough to not block holes 230. Hence, insert 220 may extend up into grill member 222 when system 210 is assembled.

As best shown in FIG. 13, grill member 222 includes a recessed portion 235 and a set of detents 236 in bottom end 224. Base 212 also includes a corresponding number of L-shaped slots 238. In this way, grill member 222 may be coupled to base 212 by inserting recessed portion 235 of bottom end 224 into cavity 218 until detents 236 pass into slots 238 and recessed portion 235 is completely within cavity 218. Base 212 and grill member 222 are rotated relative to each other to move detents 236 further into the slots. Base 212 and grill member 222 may be disassembled by rotating them in the opposite direction.

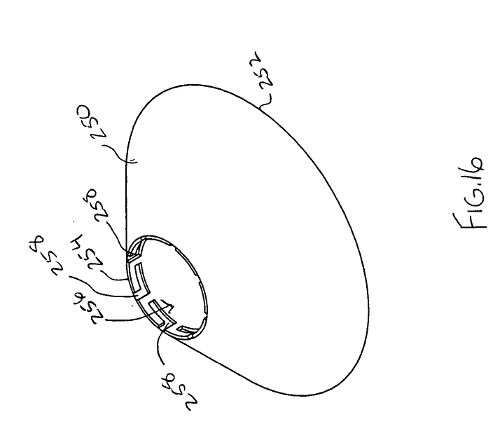

It will be appreciated that the number of detents and slots may be varied. For example, shown in FIG. 16 is another embodiment of a base 250 having a bottom end 252, an open top end 254 and a cavity 256. Disposed within cavity 256 are eight L-shaped slots 258 that may be used to receive detents on a grill member. The number of detents may be anywhere from one to eight.

As another alternative, the grilling systems may utilize a base 260 having a cavity 262 without any detents or slots as shown in FIG. 260. In such cases, the grill member may be press fit into cavity 262. To remove the grill member, it may simply be pulled from base 260.

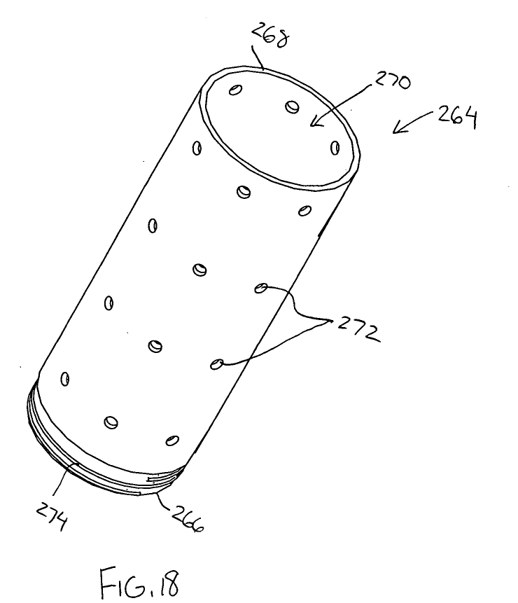

Shown in FIG. 18 is a grill member 264 having a bottom end 266, a top end 268 and a conduit 270. Grill member 264 also includes a plurality of holes 272. Formed in bottom end 266 are threads 274 that may be used to mate with corresponding threads in a base. In this way, grill member 264 may be screwed into the base.

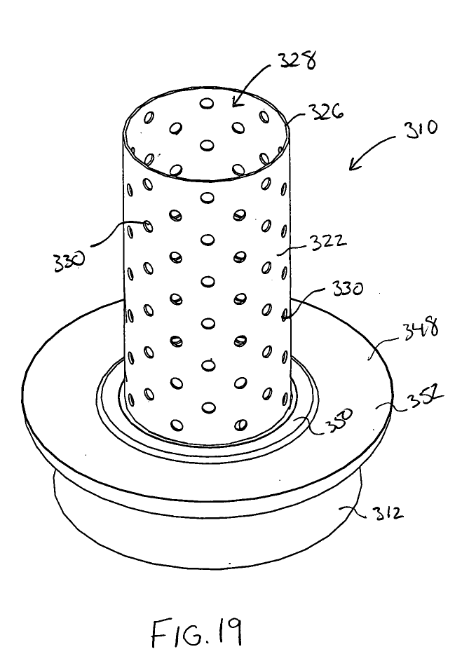

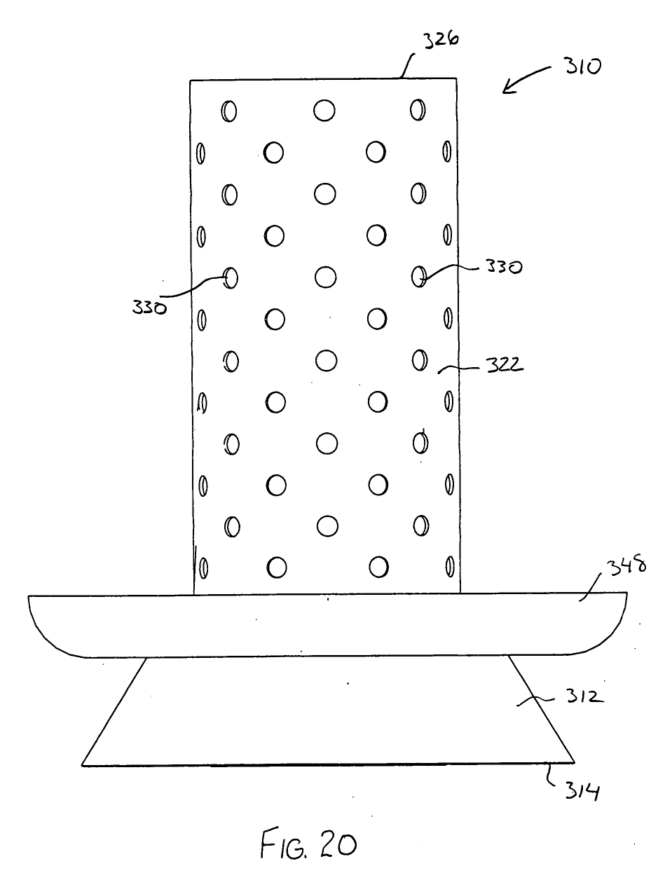

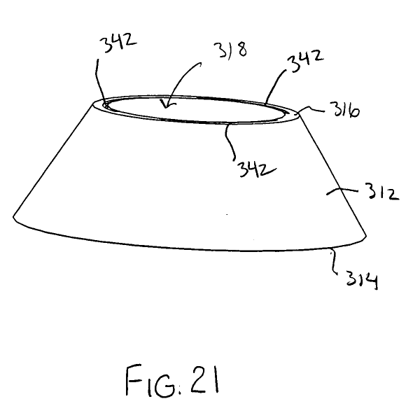

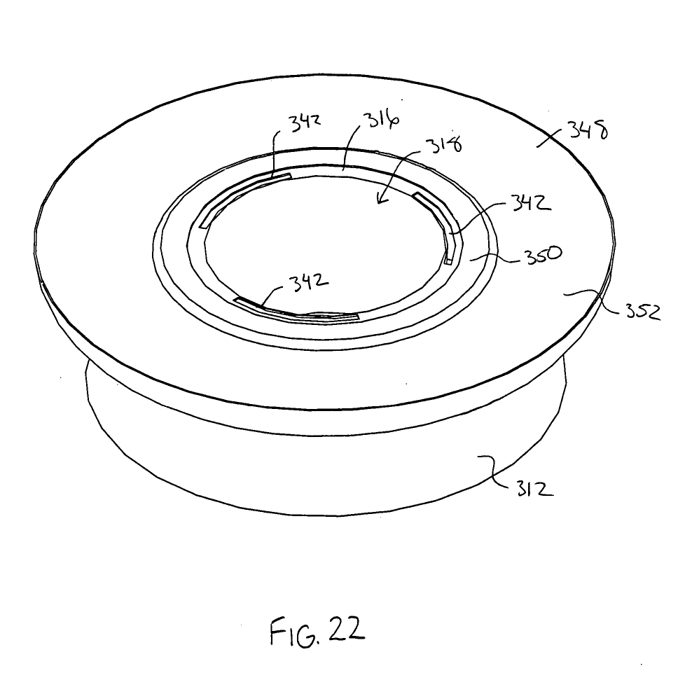

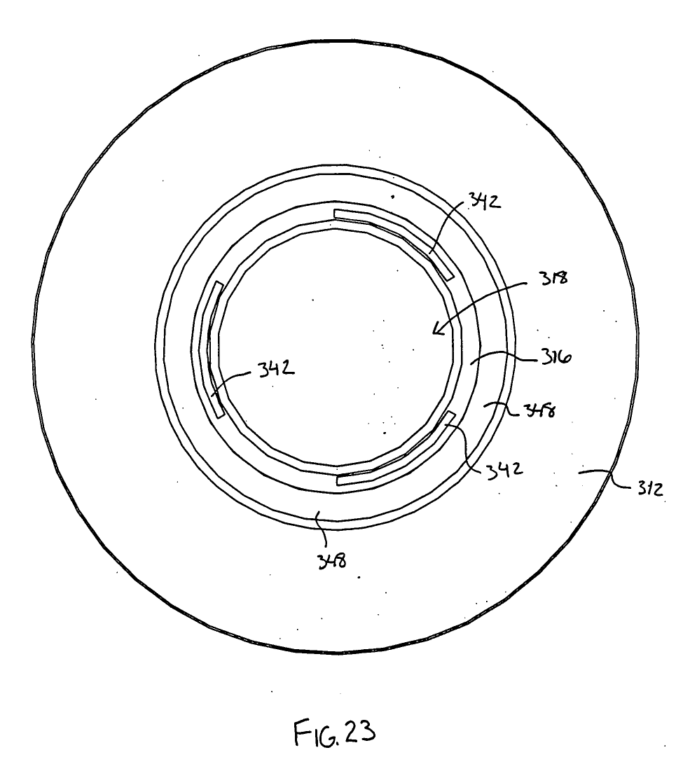

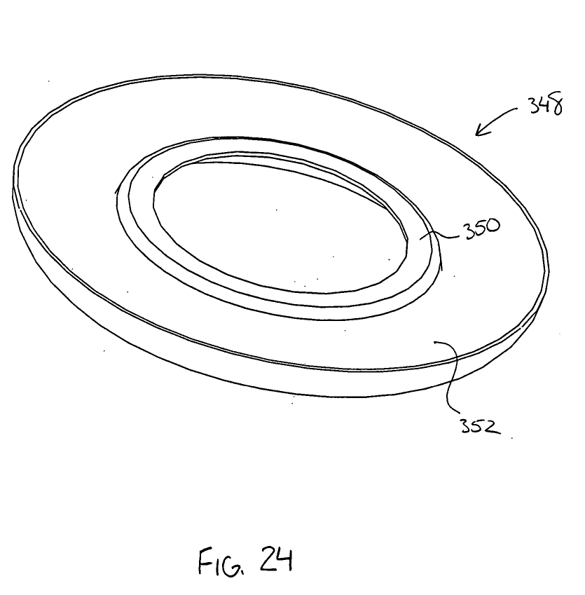

FIGS. 19-26, illustrate another embodiment of a grilling system 310. Grilling system 310 comprises a base 312 (see especially FIG. 21) that is constructed of a thermally conductive material, such as a metal, stainless steel or other grill material commonly used with grills. Base 312 is shown as being generally conical in geometry, although other shapes may be used as well. However, the conical shape provides a low center of gravity to enable to base to support a fowl, as well as permitting fluids and greases from the fowl to flow down its sides and into the grill. Base 312 has a bottom end 314 that is configured to directly rest on a grill and an open top end 316. Formed within base 312 is a cavity 318 that may be used to hold a substance that is used to create a smoke or vapor. Base 312 may be manufactured from one or more pieces of stainless steel using stamping and welding techniques known in the art. This makes the base cheaper to manufacture and reduces overall weight.

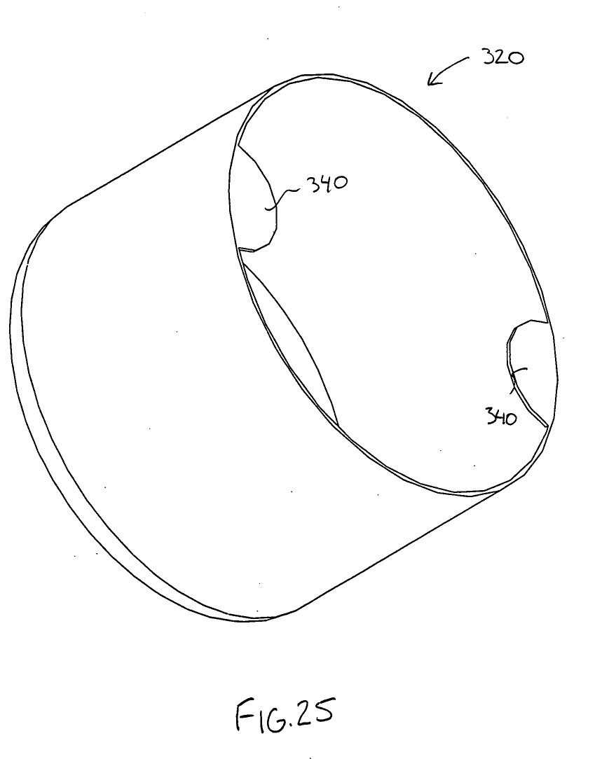

In some cases, the substance may be held directly in cavity 318, while in other cases, an insert 320 (see FIG. 25) may be placed into cavity 318 and used to hold the substance. Insert 320 may be constructed of any material that is bio-compatible with food and that may withstand grilling temperatures. Examples of materials that may be used include ceramics, metals, stainless steel, composites, and the like. Insert 320 may easily be removed from cavity 318 for cleaning and to permit substances to be placed directly into cavity 318.

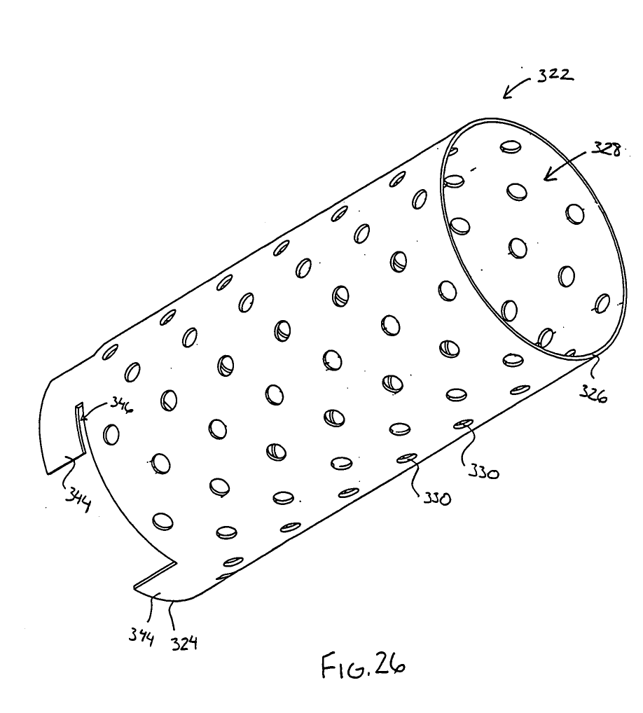

System 310 also includes a grill member 322 having an open bottom end 324, an open top end 326 and a conduit 328 (see FIG. 26) passing between the two ends. Grill member 322 as shown is cylindrical in geometry, although it will be appreciated that other shapes may be used, including those specifically tailored to mate with the interior cavity of a particular fowl, meat, or vegetable. Formed within the walls of grill member 322 are holes 330 that permit smoke and/or vapors to pass laterally through grill member 322 and into a fowl. Grill member 332 may also be constructed of a metal, such as stainless steel.

Grill system 310 may be used in a manner similar to any of the embodiments described herein. One particular advantage of grill system 310 is that insert 320 may include one or more tabs 340 to permit insert 320 to easily be inserted into and removed from cavity 318 of base 312. More specifically, a user may place his finger beneath tab 340 to lift insert 320 from base 312. If needed, both of the user's hands may be used to lift insert 320 using both tabs 340.

Another feature of grill system 310 is the ability to easily couple and uncouple grill member 322 to and from base 312. Similar to other embodiments, grill member 322 may be coupled to base 312 by twisting grill member 322 relative to base 312. As best shown in FIGS. 21-23, top end 316 of base 312 includes a set of slots 342 that extend completely through top end 316 of base 312. As shown in FIG. 26, grill member 322 includes a set of corresponding tabs 344, each having a groove 346. In this way, grill member 322 may be coupled to base 312 by inserting tabs 344 into slots 342 and twisting grill member 322 until the edges of slots 342 slide into grooves 346 to lock grill member 322 in place. To remove grill member 322, it may be rotated in the opposite direction and then lifted from base 312.

Grill system 310 may also include a collection plate 348 (see FIGS. 19, 20, and 22-24). Plate 348 may be either removably or permanently attached to base 312 and may be constructed of a metal, such as stainless steel. For example, plate 348 may simply rest on base 312 or may be welded to base 312. Plate 348 includes an inner lip 350 for resting on top end 316 of base 312 and a collection channel 352 where liquids or other substances from the item being grill my collect. In this way, plate 348 prevents unwanted liquids or substances from draining onto the grill surface, making it particularly attractive for indoor use. Following use, grill member 322 may be removed from base 312 and substances collected in plate 348 may be removed. Both components may then be washed in any conventional matter, including by placing them in a dishwasher.

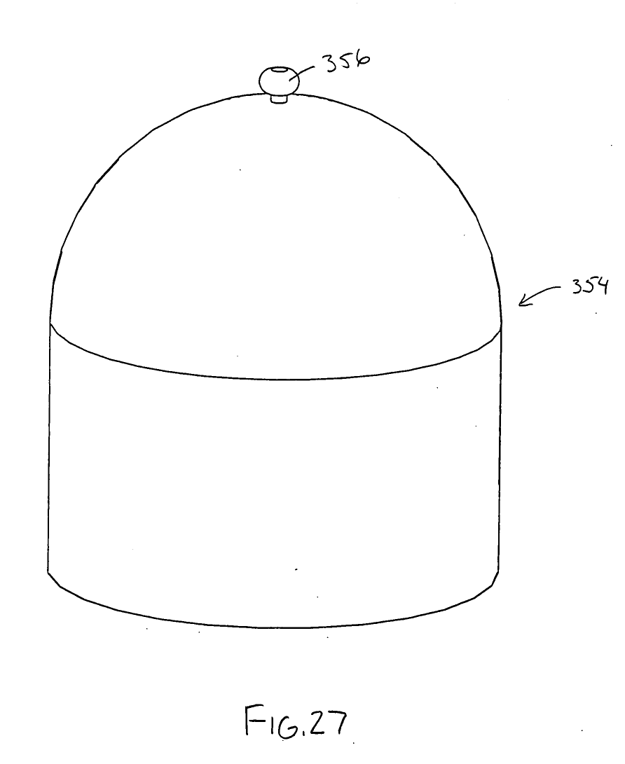

As illustrated in FIG. 27, any of the grilling systems described herein may be covered with a lid 354. A handle 356 may be attached to a top end of lid 354 to permit lid 354 to be easily lifted. Lid 354 may be constructed of a wide variety of materials, such as metal, stainless steel, plastic any the like. In some cases, lid 354 may be placed over any of the grilling systems while a fowl is being grilled. In such cases, lid 354 rests on the grill surface and completely encloses the fowl. In this way, more heat is supplied to the fowl, and smoke and/or vapors are trapped. Following grilling, lid 354 may be used to keep the cooked fowl warm.

The invention has now been described in detail for purposes of clarity and understanding. However, it will be appreciated that certain changes and modifications may be practiced within the scope of the appended claims.

What is claimed is:

1. 1. A grilling system, comprising:
a heat conductive grilling base having a bottom end and an open top end, wherein the base defines a cavity that extends to the open top end, and wherein the grill base tapers outward from the top end to the bottom end;
a grill member having an open bottom end, an open top end, and a conduit passing from the bottom end to the top end, wherein the grill member is configured to be coupled to the grilling base with a twist-on connection, with the grill member extending vertically upward from the top end of the base to permit a fowl to be inserted over the grill member and rest on the base while also permitting smoke or steam rising from the cavity to pass through the grill member to flavor the fowl.

2. A system as in claim 1, wherein the grill member includes a plurality of holes distributed between the top end and the bottom end to permit the smoke or steam to also pass laterally outward into the fowl.

3. A system as in claim 2, wherein the grill member is cylindrical in geometry and is constructed of metal.

4. A system as in claim 1, further comprising a collection plate coupled to the base.

5. A system as in claim 1, wherein the base is generally conical in geometry and is constructed of a metal.

6. A system as in claim 1, wherein the top end of the base includes a plurality of slots, and wherein the grill member includes tabs that are configured to fit within the slots to permit the grill member to be coupled to the base with the twist-on connection.

7. A system as in claim 1, further comprising a lid that is configured to enclose the grill member and the base.

8. A system as in claim 1, further comprising an insert that is configured to fit within the cavity and to hold a liquid.

9. A system as in claim 8, wherein the insert comprises a cup shaped member.

10. A system as in claim 9, wherein the insert is constructed from a material selected from a group consisting of ceramics and heat conductive materials, and wherein the insert includes at least one tab to facilitate removal of the insert.

11. A grilling system, comprising:
a heat conductive grilling base having a bottom end and an open top end, wherein the base defines a cavity that extends to the open top end;
a grill member having an open bottom end, an open top end, a conduit passing from the bottom end to the top end, and a plurality of openings distributed between the top end and the bottom end, wherein the grill member is configured to be coupled to the grilling base so as to extend vertically upward from the top end of the base to permit a fowl to be inserted over the grill member and rest on the base while also permitting smoke or steam rising from the cavity to passing through the grill member to flavor the fowl; and
and insert that is configured to fit within the cavity and to hold a liquid, wherein the insert includes at least one tab to facilitate handling of the insert.

12. A method for cooking fowl, the method comprising:
providing a heat conductive grilling base having a bottom end and an open top end, wherein the base defines a cavity that extends to the open top end;
placing a substance into the cavity;
twisting the grill member into to the base to coupled the grill member to the base, wherein the grill member has an open bottom end, an open top end, a conduit passing from the bottom end to the top end, and a plurality of openings distributed between the top end and the bottom end, and wherein the grill member is coupled to the base so as to extend vertically upward from the top end of the base;
inserting a fowl over the grill member such that the grill member extends upward into the fowl's body cavity, with the base holding the fowl in a generally vertical orientation; and
providing heat to the base to transfer heat to the grill member and to cause the substance to smoke or steam, with the smoke or steam passing up through the conduit and into the fowl through the openings and through the open top end of the grill member.

13. A method as in claim 12, further comprising placing the base onto a barbecue grill to provide the heat to the base.

14. A method as in claim 12, wherein the substance comprises moist wood chips that are placed into the cavity.

15. A method as in claim 12, wherein the substance comprises a liquid.

16. A method as in claim 15, further comprising pouring the liquid into an insert, and placing the insert into the cavity.

17. A method as in claim 16, further comprising providing a seasoning to the liquid.

18. A method as in claim 12, wherein the top end of the base includes a plurality of slots, wherein the grill member includes a plurality of tabs, and wherein the grill member is twisted to place after the tabs are placed into the slots.

19. A method as in claim 12, further comprising a collection plate coupled to the base, and collecting greases from the fowl in the collection plate.

20. A method as in claim 12, wherein the grill member comprises a metal fashioned in a cylindrical shape such that heat from the base is transferred to the interior of the fowl via the grill member, and further comprising placing a lid over the fowl.
